(19) United States
(12) Patent Application Publication
(10) Pub. No.: US 2008/0265629 A1
(43) Pub. Date: Oct. 30, 2008

(54) HEADLINER HAVING A MODULE

(75) Inventors: Ryan Fry, Warren, MI (US); Gary Skrzycki, Ortonville, MI (US); Ronald L. Jenkins, Holly, MI (US); Sandra Lassila, Rochester Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/739,317

(22) Filed: Apr. 24, 2007

(51) Int. Cl. B60R 13/02

(52) U.S. Cl. 296/214

(57) ABSTRACT

A headliner having a substrate, a foam channel, and a module. The foam channel has a standoff portion that extends away from the substrate and an adjacent portion of the foam channel. The module is disposed proximate the substrate and has an input device. The standoff portion inhibits movement of the module when the input device is actuated.

### BACKGROUND OF THE INVENTION

### Field of the Invention

The present invention relates to a headliner having a module.

### SUMMARY OF THE INVENTION

In at least one embodiment of the present invention, a headliner is provided. The headliner includes a substrate, a foam channel, and a module. The foam channel is disposed adjacent to the substrate. The foam channel has a standoff portion that extends away from the substrate and extends away from an adjacent portion of the foam channel. The module is disposed proximate the substrate and has an input device. The standoff contacts an adjacent component to inhibit movement of the module when the input device is actuated.

In at least other one embodiment of the present invention, a headliner for a vehicle is provided. The headliner includes a substrate, a foam channel, and a module. The substrate has a first surface, a second surface disposed opposite the first surface, and an opening that extends between the first and second surfaces. The foam channel is bonded to the second surface. The foam channel has a standoff portion that extends away from the second surface and extends away from an adjacent portion of the foam channel. The module is disposed adjacent to the substrate and has an input device disposed in the opening. The standoff inhibits flexing of the headliner when the input device is actuated.

In at least one additional embodiment of the present invention, a headliner is provided. The headliner includes a substrate, a control module, and first and second foam channels. The control module is disposed adjacent to the substrate and has an input device. The first and second foam channels are bonded to the substrate. The first and second foam channels have first and second standoff portions. The first and second standoff portions extend from the first and second foam channels, respectively, and away from the control module. The first and second standoff portions cooperate with the first and second foam channels to inhibit movement of the control module when the input device is actuated.

### BRIEF DESCRIPTION OF THE DRAWINGS

FIG. 1 is a perspective view of a headliner.

FIG. 2 is a top view of the headliner in the general direction indicated by line 2 in FIG. 1.

FIG. 3 is a section view of the headliner along section line 3-3.

FIG. 4 is a section view of the headliner along section line 4-4.

### DETAILED DESCRIPTION

Detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Referring to FIG. 1, and exemplary headliner 10 is shown. The headliner 10 may be configured to be disposed in a passenger compartment of a vehicle, such as a motor vehicle. For instance, the headliner 10 may be disposed proximate and generally conceal a roof structure 12 of the vehicle.

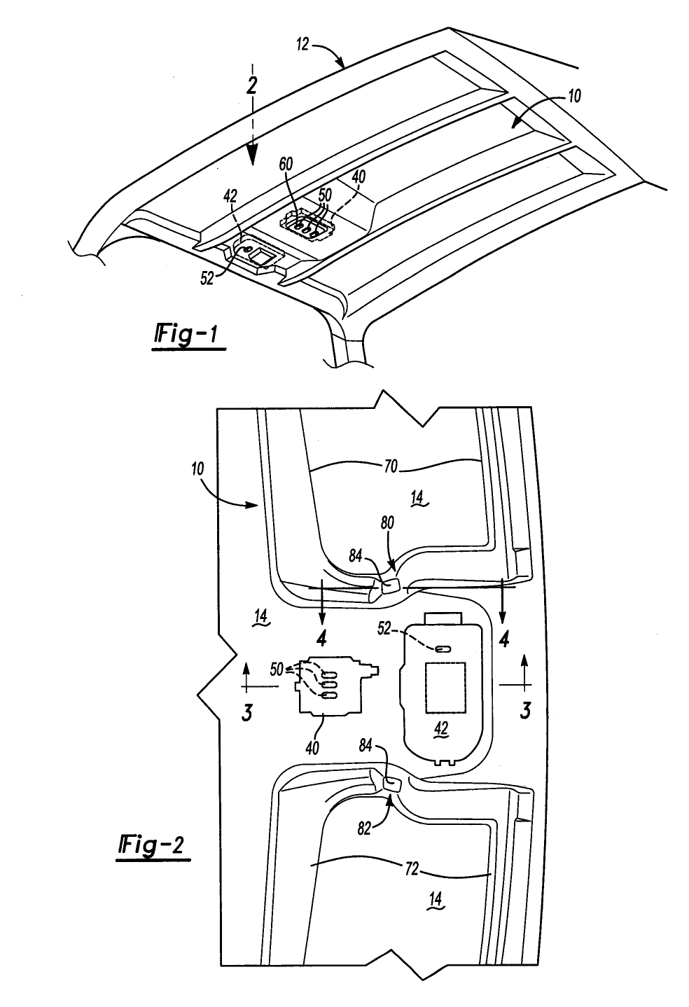

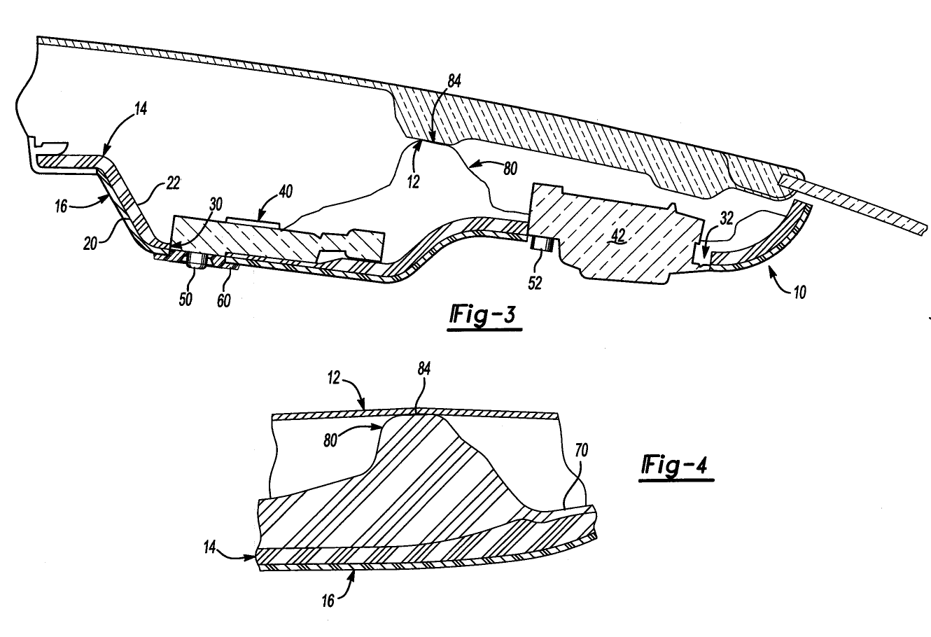

Referring to FIGS. 1 and 2, the headliner 10 may include a plurality of features. For example, the headliner 10 may include a substrate 14, a decorative layer 16, and at least one foam channel.

The substrate 14 may include a first surface 20 and a second surface 22 disposed opposite the first surface 20. The substrate 14 may have any suitable configuration. For instance, the substrate 14 may include a plurality of layers and may be provided with a laminated construction. Any suitable number of layers may be provided. In addition, the layers may be provided with any suitable materials, such a molded fiberglass, styrene, cardboard, fabric, polymeric material, fabric, woven material, non-woven material, or other materials as is known by those skilled in the art. As such, the substrate 14 may help the headliner 10 generally retain a desired shape during shipping, handling, and installation.

The decorative layer 16 may be provided on at least a portion of the substrate 14. For instance, the decorative layer 16 may be bonded to the first surface 20 of the substrate 14 and may face toward the interior of the vehicle. The decorative layer 16 provide a desired aesthetic appearance and may be made of any suitable material, such as fabric.

The headliner 10 may include one or more openings that are associated with one or more modules. In the embodiment shown, first and second openings 30,32 are provided. The first and second openings 30,32 may extend through the substrate 14 and the decorative layer 16. In at least one embodiment, a portion of a module may be disposed in an associated opening as will be discussed in more detail below.

One or more modules may be provided with the headliner 10. In the embodiment shown, a first module 40 and a second module 42 are provided. The first and second modules 40,42 may have any suitable configuration. For instance, the first and second modules 40,42 may be configured to control and/or provide feedback related to the status or operation of at least one device. In the exemplary embodiment shown, the first module 40 may be configured to remotely control a device, such as a garage door opener, via radio frequency communication or the like, while the second module 42 may be configured to directly or non-remotely control an associated device like a light. Of course the present invention contemplates that the first and second modules may incorporation remote or non-remote control of any suitable combinations thereof.

The first and second modules 40,42 may each include first and second input devices, 50,52, respectively. The input devices 50,52 may have any suitable configuration. For instance, the input devices 50,52 may have similar or different configurations and may be configured a button, sensor, or the like. In at least one embodiment, the first and/or second input devices 50,52 may be disposed proximate or extend into or through the first and second openings 30,32, respectively, to facilitate identification and use by a vehicle occupant.

The first and second modules 40,42 may be disposed adjacent to the headliner 10. Moreover, the first and/or second modules 40,42 may be coupled to the headliner 10 in any suitable manner, such as with a fastener, adhesive, hook and loop material, or the like. In addition, a bezel 60 may be provided to help couple a module to the headliner 10 and/or provide a desired aesthetic appearance. In the embodiment shown, a bezel 60 is disposed adjacent to the decorative layer 16 and the first opening 30 and may be coupled to the headliner 10 and/or first module 40. Moreover, the bezel 60 may include an opening for receiving at least one input device, such as the first input device 50. Alternatively, a bezel may be associated with another module or may be omitted in one or more embodiments of the present invention.

The headliner 10 may also include at least one foam channel. For example, first and second foam channels 70,72 may be provided. The first and second foam channels 70,72 may be disposed adjacent to the second surface 22 of the substrate 14. Moreover, the first and second foam channels 70,72 may be bonded to the second surface 22 of the substrate 14 using any suitable technique, such as with an adhesive or foam-in-place construction. The foam channels 70,72 may be made of any suitable material, such as a polymeric material like urethane. In addition, the foam channels 70,72 may have any suitable configuration. For instance, the foam channels 70,72 may be disposed near the first and second modules 40,42. In addition, the foam channels 70,72 may include one or more linear portions. As such, the foam channels 70,72 may act as reinforcement ribs that help provide structural reinforcement and inhibit movement or warping of the headliner 10.

At least one foam channel may include a standoff portion. In the embodiment shown, the first and second foam channels 70,72 include first and second standoff portions 80,82, respectively. For instance, the first and second standoff portions 80,82 may be integrally formed with the first and second foam channels 70,72, respectively. The first and second standoff portions 80,82 may be configured as protrusions that extend away from the second surface 22 and/or away from an adjacent portion of an associated foam channel. In one exemplary embodiment, the first and second standoff portions 80,82 may be generally tapered in a direction extending away from the first and second foam channels 70,72 to help distribute force. The first and second standoff portions 80,82 may extend from approximately 5mm to 60mm from an adjacent portion of an associated foam channel in at least one embodiment of the present invention to accommodate packaging requirements and provide a desired level of performance.

The standoff portions 80,82 may each include an end surface 84 that may be configured to contact a vehicle component, such as a stationary component like the roof structure 12. As such, the standoff portions 80,82 may cooperate with the foam channels 70,72 and the vehicle component to help inhibit movement or flexing of the headliner 10 when an input device of at least one module 40,42 is actuated. In at least one embodiment, the foam channels 70,72 and standoff portions 80,82 may be more resilient than other portions of the headliner 10 or substrate 14 to help inhibit flexing.

At least one standoff portion may be disposed near at least one module. In the embodiment shown, the first and second standoff portions 80,82 are generally disposed between the first and second modules 40,42. In at least one embodiment, the first and second standoff portions 80,82 may be disposed along a common axis that extends between the first and second modules 40,42. Moreover, the first and second standoff portions 80,82 may be generally disposed along opposite sides of at least one module. As such, the first and second standoff portions 80,82 may help inhibit movement the first and second modules 40,42 in one or more directions when an associated input device 50,52 is actuated. In at least one embodiment, a standoff may be provided along a side of a module that is nearest the input device to help provide localized support to inhibit module movement.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A headliner comprising:
a substrate;
a foam channel disposed adjacent to the substrate, the foam channel having a standoff portion that extends away from the substrate and an adjacent portion of the foam channel; and
a module disposed proximate the substrate and having an input device;
wherein the standoff portion inhibits movement of the module when the input device is actuated.

2. The headliner of claim 1 wherein the standoff portion is spaced apart from the module and contacts an adjacent component to inhibit movement of the module when the input device is actuated.

3. The headliner of claim 1 wherein the module includes a light source and the input device is configured to control operation of the light source.

4. The headliner of claim 1 wherein the module is configured to remotely control a device.

5. The headliner of claim 4 wherein the device is a garage door opener.

6. The headliner of claim 1 further comprising first and second modules having first and second input devices, respectively, wherein the standoff portion is generally disposed between the first and second modules to inhibit movement of the first module when the first input device is actuated and to inhibit movement of the second module when the second input device is actuated.

7. The headliner of claim 1 wherein the module is disposed adjacent to a back surface of the substrate.

8. A headliner for a vehicle, comprising:
a substrate having a first surface, a second surface disposed opposite the first surface, and an opening extending between the first and second surfaces;
a foam channel bonded to the second surface, the foam channel having a standoff portion extending away from the second surface and an adjacent portion of the foam channel; and
a module disposed adjacent to the substrate and having an input device disposed in the opening;
wherein the standoff portion inhibits flexing of the headliner when the input device is actuated.

9. The headliner of claim 8 further comprising a bezel disposed proximate the first surface, the bezel being disposed around the input device and coupled to the module.

10. The headliner of claim 9 wherein the bezel couples the module to the headliner.

11. The headliner of claim 8 wherein the foam channel is made of urethane.

12. The headliner of claim 8 wherein the standoff portion is spaced apart from the module.

13. The headliner of claim 8 wherein the standoff portion has a thickness at least twice that of the adjacent portion of the foam channel.

14. The headliner of claim 8 wherein the standoff portion includes an end surface that engages a body structure of the vehicle.

15. A headliner comprising:
a substrate;
a control module disposed adjacent to the substrate and having an input device; and
first and second foam channels bonded to the substrate, the first and second foam channels having first and second standoff portions extending from the first and second foam channels, respectively, and away from the control module;
wherein the first and second standoff portions cooperate with the first and second foam channels to inhibit movement of the control module when the input device is actuated.

16. The headliner of claim 15 wherein the first and second foam channels are spaced apart from the module.

17. The headliner of claim 15 wherein the first and second standoff portions are generally disposed on opposite sides of the module.

18. The headliner of claim 15 wherein the module is disposed between the first and second foam channels.

19. The headliner of claim 15 further comprising first and second modules, wherein the first and second standoff portions are generally disposed between the first and second modules.

20. The headliner of claim 19 wherein the first and second modules are disposed between and spaced apart from the first and second foam channels.
